(19) United States
(12) Patent Application Publication
(10) Pub. No.: US 2010/0290211 A1
(43) Pub. Date: Nov. 18, 2010

(54) LAMP HOLDER, ILLUMINATING DEVICE AND DISPLAY DEVICE

(75) Inventor: Mitsuhiro Takeba, Osaka-shi (JP)

Correspondence Address: SHARP KABUSHIKI KAISHA;C/O KEATING & BENNETT, LLP, 1800 Alexander Bell Drive, SUITE 200, Reston, VA, 20191, US

(73) Assignee: SHARP KABUSHIKI KAISHA, Osaka-shi, Osaka (JP)

(21) Appl. No.: 12/863,476

(22) PCT Filed: Oct. 29, 2008
(86) PCT No.: PCT/JP2008/069620

§ 371 Date: Jul. 19, 2010

(30) Foreign Application Priority Data
Mar. 6, 2008 (JP) 2008-055966

(51) Int. Cl. G02F 1/13357; F21V 19/00; F21V 17/06; F21V 21/00; F21V 1/00

(52) U.S. Cl. 362/97.1; 362/382; 362/433; 362/217.14; 362/217.08

(57) ABSTRACT

Provided is a lamp holder by which a pitch of fluorescent tubes and the number of the fluorescent tube used can be changed without preparing a new lamp holder application to such change, in the case of changing the pitch of the fluorescent tubes and the number of the fluorescent tubes used. A lamp holder (6) is provided with a fixed member (11) and a holding member (12). The fixed member (11) and the holding member (12) are separated from each other. The holding member (12) can be attached to and detached from the fixed member (11), and the holding member (12) can be attached to a discretionary position on the fixed member (11).

### TECHNICAL FIELD

The present invention relates to a lamp holder, an illuminating device and a display device.

### BACKGROUND ART

Conventionally, an illuminating device that uses a fluorescent lamp as a light source is known and used as a backlight unit for a display device such as a liquid crystal display device and the like (e.g., see a patent document 1).

FIG. 9 shows simply an example of a structure of a conventional liquid crystal display device. Hereinafter, the structure of the conventional liquid crystal display device is described with reference to FIG. 9.

In the conventional liquid crystal display device, as shown in FIG. 9, a backlight unit 120 is disposed on a rear-surface side of a liquid crystal display panel 110. And, light emitted from the backlight unit 120 is shined onto the rear surface of the liquid crystal display panel 110, so that an image is displayed on a display surface (front surface) of the liquid crystal display panel 110.

The above-described backlight unit 120 includes at least: a backlight chassis 101; a fluorescent lamp 102 housed in the backlight chassis 101; an optical sheet 103 that performs diffusion and the like of light from the fluorescent lamp 102; and a reflection sheet 104 that reflects the light from the fluorescent lamp 102. And, the fluorescent lamp 102 and the optical sheet 103 are supported by a lamp holder 105 that is fixed on the backlight chassis 101.

The lamp holder 105 is composed of a structure that includes a base portion 105a that has an engagement pin 105d; a holding portion 105b that holds the fluorescent lamp 102; and a strut portion 105c that supports the optical sheet 103 which are unitarily formed. The fixing of the lamp holder 105 onto the backlight chassis 101 is performed by engaging the engagement pin 105d of the lamp holder 105 with the backlight chassis 101.

Patent document 1: JP-A-2007-250268

### DISCLOSURE OF THE INVENTION

### Problems to be Solved by the Invention

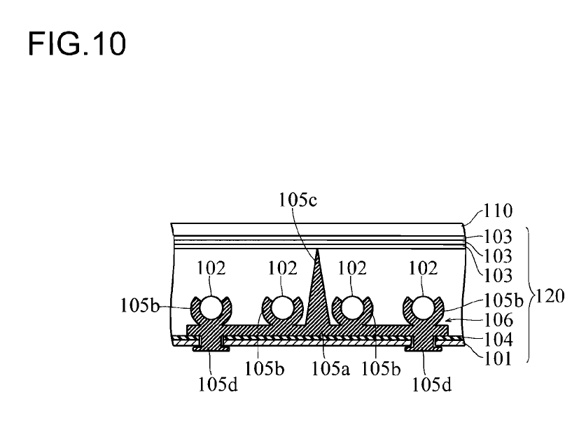

In the above-described conventional structure, in changing the pitch of the fluorescent lamps and the number of fluorescent lamps to be used, there is a disadvantage that the lamp holder must be replaced. For example, in narrowing the pitch of the fluorescent lamps 102 from the state shown in FIG. 9, instead of the lamp holder 105, it is necessary to mount a lamp holder 106 (see FIG. 10), whose holding portion 105b has a pitch narrower than the pitch of the holding portion 105b of the lamp holder 105, on the backlight chassis 101.

In other words, there is a problem that in the above-described conventional structure, in changing the pitch of the fluorescent lamps and the number of fluorescent lamps to be used, it is necessary to newly prepare a lamp holder depending on the change.

The present invention has been made to deal with the above conventional problems, and it is an object of the present invention to provide a lamp holder, an illuminating device and a display device that, in changing a pitch of fluorescent lamps and the number of fluorescent lamps to be used, allow the change of the pitch of the fluorescent lamps and the number of fluorescent lamps to be used without newly preparing a lamp holder depending on the change.

### Means for Solving the Problem

To achieve the object, a lamp holder according to a first aspect of the present invention includes: a fix member that is fixed on a chassis; and a holding member that holds a fluorescent lamp; wherein the fix member and the holding member are separated from each other; and the holding member is removably attached to the fix member and the holding member is attachable to an arbitrary position of the fix member.

In the lamp holder according to the first aspect, as described above, the fix member (member fixed on the chassis) and the holding member (member for holding the fluorescent lamp) are separated from each other, the holding member is removably attached to the fix member and the holding member is so structured as to be attachable to an arbitrary position of the fix member, so that it is possible to arbitrarily change the attachment position of the holding member with respect to the chassis (fix member) and the number of holding members to be attached. Because of this, in changing the pitch of the fluorescent lamps and the number of fluorescent lamps to be used, it is possible to change the attachment position of the holding member with respect to the chassis (fix member) and the number of holding members to be attached in accordance with the change. Accordingly, in changing the pitch of the fluorescent lamps and the number of fluorescent lamps to be used, it becomes possible to change the pitch of the fluorescent lamps and the number of fluorescent lamps to be used without newly preparing a lamp holder depending on the change.

In the lamp holder according to the first aspect described above, preferably, the fix member includes a guide groove; and the holding member includes a pedestal that is fitted in the guide groove of the fix member. According to this structure, by fitting the pedestal of the holding member into the guide groove of the fix member, it is possible to obtain a state in which the holding member is attached to the chassis (fix member). In this way, it is possible to easily attach the holding member to the chassis (fix member).

In this case, preferably, the guide groove of the fix member is formed into a rail-shape that extends in a predetermined direction. According to this structure, it is possible to slide the holding member in the predetermined direction (direction in which the guide groove of the fix member extends) with the holding member attached to the chassis (fix member). In this way, it is possible to easily change the attachment position of the holding member with respect to the chassis (fix member).

In the structure in which the guide groove of the fix member is formed into the rail-shape that extends in the predetermined direction, preferably, a plurality of projections arranged in a predetermined direction are disposed in the guide groove of the fix member; and an engagement piece that engages with the projection of the fix member is disposed on the pedestal of the holding member. According to this structure, after the holding member is slid in the predetermine direction (direction in which the guide groove of the fix member extends) and moved to a desired position, it is possible to engage the projection of the fix member with the engagement piece of the holding member at the desired position. Accordingly, because the holding member is fixed at the desired position, it is possible to alleviate the holding member deviating from the desired position.

Besides, the lamp holder according to the first aspect described above preferably further includes a strut member that supports an optical sheet that at least diffuses light from the fluorescent lamp; wherein the fix member, the holding member and the strut member are separated from each other; and the strut member is removably attached to the fix member and the strut member is attachable to an arbitrary position of the fix member. According to this structure, it is possible to arbitrarily change the attachment position of the strut member (member that supports the optical sheet) with respect to the chassis (fix member) and the number of strut members to be attached. Accordingly, in the lamp holder that is able to support the optical sheet as well besides the fluorescent lamp, in changing the pitch of the fluorescent lamps and the number of fluorescent lamps to be used, it is possible to change the pitch of the fluorescent lamps and the number of fluorescent lamps to be used without newly preparing a lamp holder depending on the change.

Besides, the lamp holder according to the first aspect described above preferably further includes a spacer member that is disposed between holding members adjacent to each other. According to this structure, it is possible to hold the distance between the holding members adjacent to each other. In other words, it is possible to hold the distance between fluorescent lamps adjacent to each other.

An illuminating device according to a second aspect of the present invention includes: the lamp holder according to the first aspect; and a fluorescent lamp that is held by the lamp holder. According to this structure, in changing the pitch of the fluorescent lamps and the number of fluorescent lamps to be used, it is possible to change the pitch of the fluorescent lamps and the number of fluorescent lamps to be used without newly preparing a lamp holder depending on the change. In this case, it is possible to share the lamp holder between devices that are different from each other in the pitch of the fluorescent lamps and the number of fluorescent lamps to be used, which allows the production cost to be reduced.

A display device according to a third aspect of the present invention includes the illuminating device according to the second aspect; and a display panel onto which light emitted from the illuminating device is shined. According to this structure, in changing the pitch of the fluorescent lamps and the number of fluorescent lamps to be used, it is possible to change the pitch of the fluorescent lamps and the number of fluorescent lamps to be used without newly preparing a lamp holder depending on the change. In this case, it is possible to share the lamp holder between devices that are different from each other in the pitch of the fluorescent lamps and the number of fluorescent lamps to be used, which allows the production cost to be reduced.

### Advantages of the Invention

As described above, according to the present invention, in changing a pitch of fluorescent lamps and the number of fluorescent lamps to be used, it is possible to obtain a lamp holder, an illuminating device and a display device that allow the change of the pitch of the fluorescent lamps and the number of fluorescent lamps to be used without newly preparing a lamp holder depending on the change.

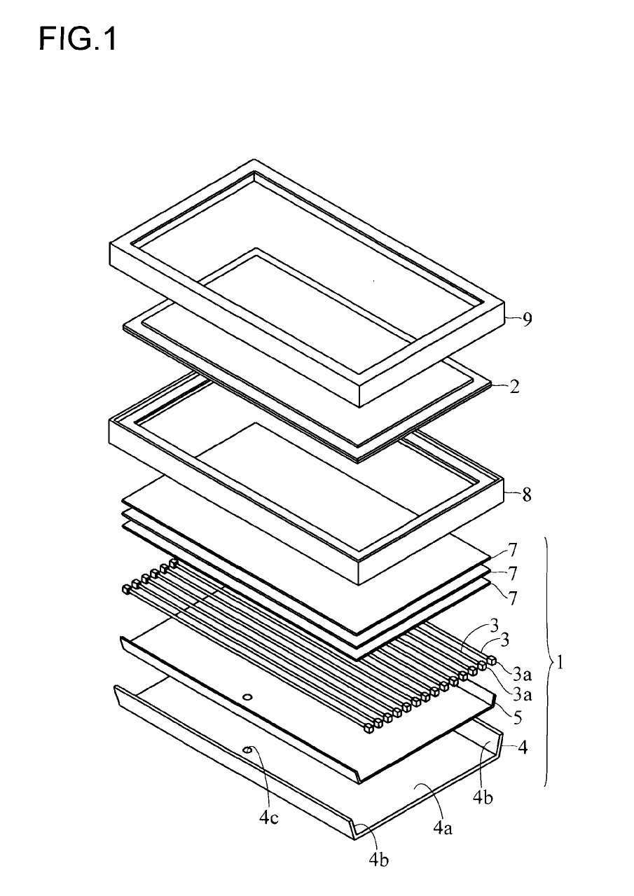

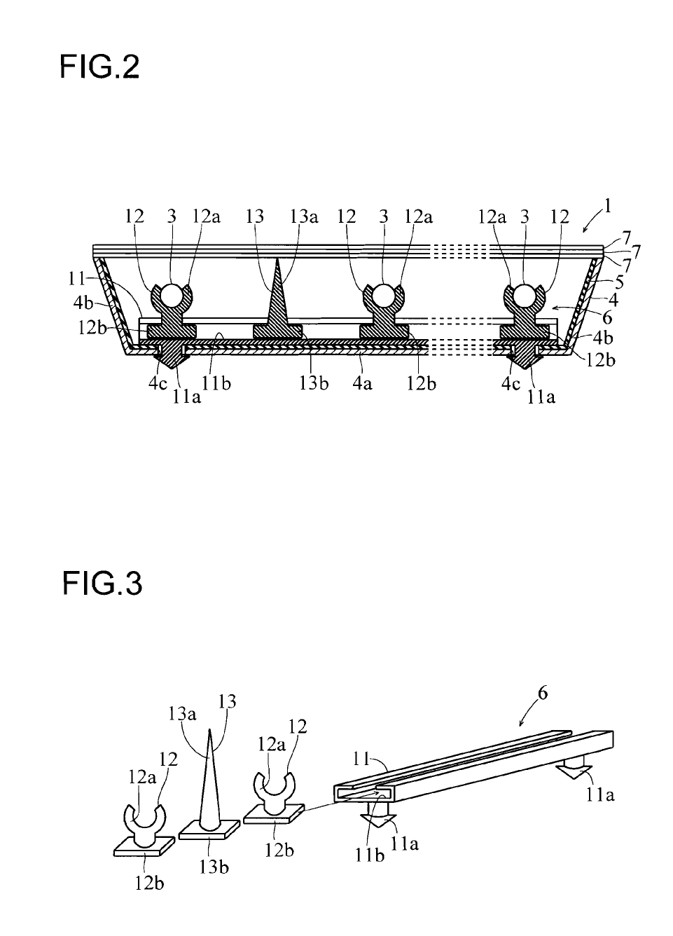

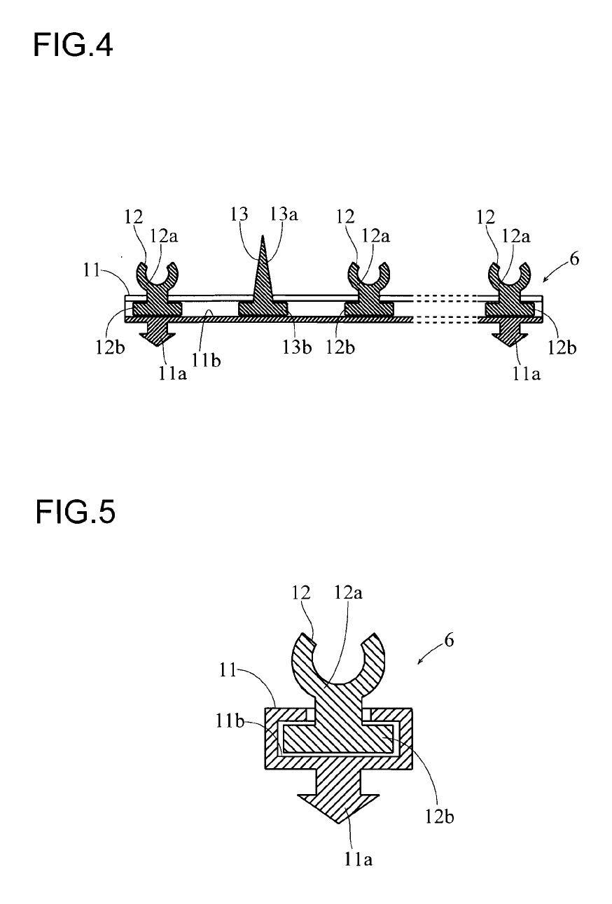

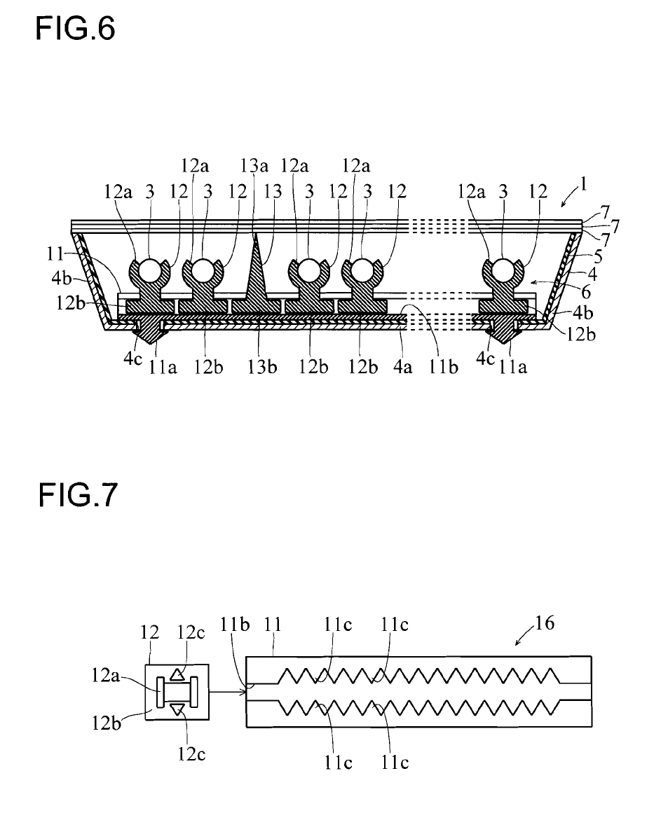

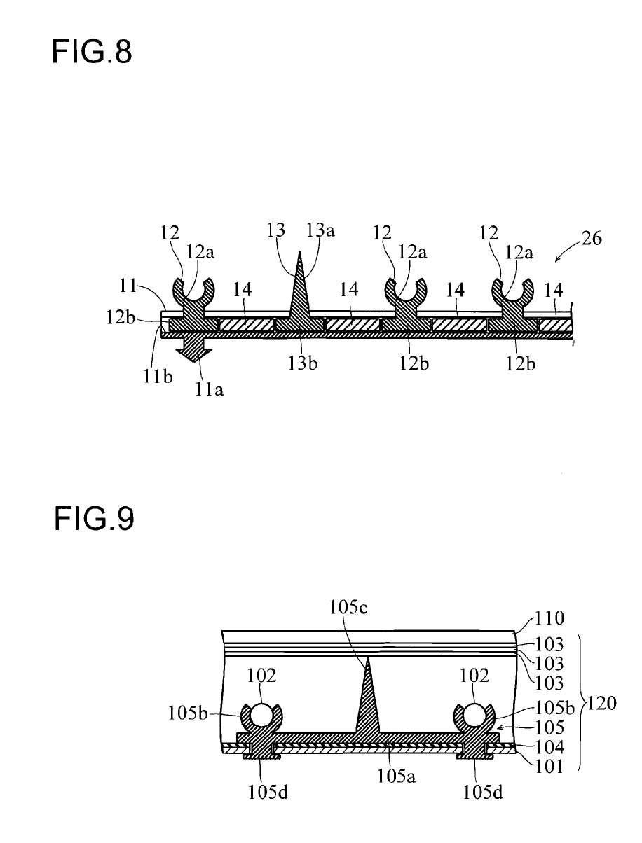

### BRIEF DESCRIPTION OF THE DRAWINGS

[FIG. 1] is an exploded perspective view of a liquid crystal display device in which a backlight unit according to a first embodiment of the present invention is disposed.

[FIG. 2] is a sectional view of the backlight unit according to the first embodiment of the present invention.

[FIG. 3] is an exploded perspective view of a lamp holder used for the backlight unit according to the first embodiment shown in FIG. 2.

[FIG. 4] is a sectional view of a lamp holder used for the backlight unit according to the first embodiment shown in FIG. 2.

[FIG. 5] is a sectional view of a lamp holder used for the backlight unit according to the first embodiment shown in FIG. 2.

[FIG. 6] is a diagram to describe an effect of the first embodiment.

[FIG. 7] is a plan view of a lamp holder used for a backlight unit according to a second embodiment of the present invention.

[FIG. 8] is a sectional view of a lamp holder used for a backlight unit according to a third embodiment of the present invention.

[FIG. 9] is a diagram simply showing an example of a structure of a conventional liquid crystal display device.

[FIG. 10] is a diagram to describe a conventional problem.

### LIST OF REFERENCE SYMBOLS

1 backlight unit (illuminating device)

2 liquid crystal display panel (display panel)

3 fluorescent lamp

4 backlight chassis (chassis)

6, 16, 26 lamp holder

7 optical sheet

11 fix member

11b guide groove

11c projection

12 holding member

12b pedestal

12c engagement piece

13 strut member

14 spacer member

### BEST MODE FOR CARRYING OUT THE INVENTION

### First Embodiment

First, a backlight unit in a first embodiment and a liquid crystal display device in which the backlight unit is disposed are described with reference to FIGS. 1 to 5.

In a liquid crystal display device (display device) in which a backlight unit 1 in the first embodiment is disposed, as shown in FIG. 1, the backlight unit 1 is disposed on a rear-surface side of a liquid crystal display panel 2. And, a structure is employed, in which light (surface light) emitted from the backlight unit 1 is shined onto the rear surface of the liquid crystal display panel 2, so that an image is displayed on a display surface (front surface) of the liquid crystal display panel 2. Here, the backlight unit 1 is an example of an “illuminating device” in the present invention and the liquid crystal display panel 2 is an example of a “display panel” in the present invention. Hereinafter, a structure of the backlight unit 1 in the first embodiment is described in detail.

The backlight unit 1 in the first embodiment, as shown in FIGS. 1 and 2, is a direct-type backlight unit and has a structure in which a light source is disposed right under the liquid crystal display panel 2. The light source of the backlight unit 1 includes a plurality of elongate fluorescent lamps 3 that are so arranged as to be parallel to each other and is housed in a housing region of a backlight chassis 4. Besides, on each of both ends of the fluorescent lamp 3, a holder 3a that engages with the backlight chassis 4 is mounted. And, the holder 3a engages with the backlight chassis 4, so that the fluorescent lamp 3 is fixed to the backlight chassis 4.

The backlight chassis 4 includes a metal plate that is bent into substantially a concave shape. Specifically, the backlight chassis 4 includes a bottom portion 4a and a pair of side portions 4b that are formed upright at both ends of the bottom portion 4a. And, a region enclosed by the bottom portion 4a and the side portions 4b of the backlight chassis 4 is the housing region in which the fluorescent lamp 3 is housed. Besides, the bottom portion 4a of the backlight chassis 4 is provided with an engagement hole 4c for fixing a lamp holder 6 (fix member 11), described later, to the backlight chassis 4. Here, the backlight chassis 4 is an example of a “chassis” in the present invention.

Besides, a reflection sheet 5 formed of a resin sheet is disposed in the housing region of the backlight chassis 4. This reflection sheet 5 is used to reflect light from the fluorescent lamp 3 toward the front side and is disposed along the surface on the housing-region side of the bottom portion 4a and the side portion 4b of the backlight chassis 4.

Further, the lamp holder 6 formed of a high-reflection polycarbonate resin and the like is disposed in the housing region of the backlight chassis 4. This lamp holder 6 is used to support the fluorescent lamp 3 in the housing region of the backlight chassis 4 and is disposed on a predetermined region (region corresponding to a region near a center portion in a longitudinal direction of the fluorescent lamp 3) of the bottom portion 4a of the backlight chassis 4. In other words, the fluorescent lamp 3 is supported by the lamp holder 6 at the region near the center portion in the longitudinal direction. Here, the lamp holder 6, for simplification of the drawing, is not shown in FIG. 1.

Besides, the lamp holder 6, as shown in FIGS. 2 to 5, includes at least the fix member 11 fixed on the bottom portion 4a of the backlight chassis 4 and the holding member 12 for holding the fluorescent lamp 3.

The fix member 11 has an engagement pin 11a that engages with the engagement hole 4c of the backlight chassis 4; and is so structured as to be fixed on the bottom portion 4a of the backlight chassis 4 when the engagement pin 11a is engaged with the engagement hole 4c of the backlight chassis 4. Here, in the state in which the fix member 11 is fixed on the bottom portion 4a of the backlight chassis 4, the reflection sheet 5 is sandwiched between the fix member 11 and the bottom portion 4a of the backlight chassis 4.

The holding member 12 has a clip 12a that grasps the fluorescent lamp 3 and is so structured as to hold the fluorescent lamp 3 by grasping the fluorescent lamp 3 with the clip 12a. The clip 12a of the holding member 12 is formed of an annular body which is partially cut away. And, the fluorescent lamp 3 is held by the clip 12a of the holding member 12 by inserting the fluorescent lamp 3 into the inside of the annular body from the cut-away portion of the annular body.

Here, in the lamp holder 6 in the first embodiment, the fix member 11 and the holding member 12 are separated from each other. And, in the fix member 11 and the holding member 12 that are separated from each other, the holding member 12 is removably attached to the fix member 11 and the holding member 12 is so structured as to be attachable to an arbitrary position of the fix member 11.

Specifically, the fix member 11 has a rail-shape guide groove 11b that extends in a predetermined direction and has a structure in which the engagement pin 11a is unitarily formed with the guide groove 11b. The guide groove 11b of the fix member 11 is formed of a space that is enclosed by a bottom portion, a pair of side portions (portions formed upright at both ends of the bottom potion) and a front portion (portion that faces the bottom portion with a predetermined distance away from the bottom portion) through which a slit is formed. Here, the fix portion 11 is fixed on the bottom portion 4a of the backlight chassis 4 in such a way that the predetermined direction in which the guide groove 11b extends and the longitudinal direction of the fluorescent lamp 3 meet with each other at right angles.

Besides, the holding member 12 has a pedestal 12b that is fitted in the guide groove 11b of the fix member 11 and has a structure in which the clip 12a is unitarily formed with the pedestal 12b. And, the pedestal 12b of the holding member 12 is fitted into the guide groove 11b of the fix member 11, so that the clip 12a of the holding member 12 protrudes forward via the slit of the front portion of the fix member 11.

In the lamp holder 6 having the above structure, it is possible to attach the holding member 12 to the fix member 11 by fitting the pedestal 12b of the holding member 12 into the guide groove 11b of the fix member 11; and it is possible to detach the holding member 12 from the fix member 11 by pulling out the pedestal 12b of the holding member 12 from the guide groove 11b of the fix member 11. In other words, it is possible to say that the holding member 12 is removably attached to the fix member 11. Besides, because the guide groove 11b of the fix member 11 has the rail shape that extends in the predetermined direction, after the pedestal 12b of the holding member 12 is fitted into the guide groove 11b of the fix member 11, it is also possible to slide the holding member 12 in the predetermined direction (direction in which the guide groove 11b of the fix member 11 extends). In other words, it is possible to say that the holding member 12 is attachable to an arbitrary position of the fix member 11.

Besides, the lamp holder 6 in the first embodiment, besides the fix member 11 and the holding member 12, further includes a strut member (member for supporting the optical sheet 7 described later) 13 that is separated from the fix member 11 and the holding member 12. And, the strut member 13, like the holding member 12, is removably attached to the fix member 11 and attachable to an arbitrary position of the fix member 11. Specifically, the strut member 13 has: a strut 13a for supporting the optical sheet 7 described later: and a pedestal 13b that is fitted in the guide groove 11b of the fix member 11; and a structure is composed, in which these are unitarily formed with each other.

Besides, as shown in FIGS. 1 and 2, so as to cover the housing region of the backlight chassis 4 from the front side (so as to cove the fluorescent lamp 3 from the front side), the optical sheet 7 that diffuses and collects light from the fluorescent lamp 3 is disposed on the front side of the backlight chassis 4. The optical sheet 7 includes a diffusion sheet and a lens sheet and the like. And, the optical sheet 7 is supported by the strut 13a of the strut member 13 of the lamp holder 6.

The backlight unit 1 in the first embodiment is structured as described above.

Besides, as shown in FIG. 1, a frame-shape frame 8 is disposed between the backlight unit 1 and the liquid crystal display panel 2. And, the liquid crystal display panel 2 disposed in front of the backlight unit 1 is supported by the frame 8. Besides, a frame-shape bezel 9 is disposed on the front side of the liquid crystal display panel 2 and an outer edge of the liquid crystal display panel 2 is sandwiched between the frame 8 and the bezel 9.

In the first embodiment, as described above, the fix member (member that is fixed to the backlight chassis 4) 11 and the holding member (member for holding the fluorescent lamp 3) 12 of the lamp holder 6 are separated from each other; the holding member 12 is removably attached to the fix member 11 and the holding member 12 is so structured as to be attachable to an arbitrary position of the fix member 11, so that it is possible to arbitrarily change the attachment position of the holding member 12 with respect to the backlight chassis 4 (fix member 11) and the number of holding members 12 to be attached. Because of this, in changing the pitch of the fluorescent lamps 3 and the number of fluorescent lamps 3 to be used, it is possible to change the attachment position of the holding member 12 with respect to the backlight chassis 4 (fix member 11) and the number of holding members 12 to be attached in accordance with the change. Accordingly, in changing the pitch of the fluorescent lamps 3 and the number of fluorescent lamps 3 to be used, it is possible to change the pitch of the fluorescent lamps 3 and the number of fluorescent lamps 3 to be used without newly preparing a lamp holder depending on the change. For example, in narrowing the pitch of the fluorescent lamps 3 from the state shown in FIG. 2, the number of holding members 12 to be attached to the fix member 11 is increased and the pitch of the holding members 12 is narrowed, so that it is possible to obtain a state shown in FIG. 6. On the other hand, in widening the pitch of the fluorescent lamps 3, an unnecessary holding member 12 is pulled out from the fix member 11 and the pitch of the remaining holding members 12 is widened.

In this case, it is possible to share the lamp holder 6 between devices that are different from each other in the pitch of the fluorescent lamps 3 and the number of fluorescent lamps 3 to be used, which allows the production cost to be reduced.

Besides, in the first embodiment, as described above, the guide groove 11b is disposed in the fix member 11 and the pedestal 12b fitted in the guide groove 11b of the fix member 11 is disposed on the holding member 12; the pedestal 12b of the holding member 12 is fitted into the guide groove 11b of the fix member 11, so that it is possible to obtain the state in which the holding member 12 is attached to the backlight chassis 4 (fix member 11). In this way, it is possible to easily attach the holding member 12 to the backlight chassis 4 (fix member 11).

Besides, in the first embodiment, as described above, because the guide groove 11b of the fix member 11 is formed into the rail shape that extends in the predetermined direction, it is possible to slide the holding member 12 in the predetermined direction (direction in which the guide groove 11b of the fix member 11 extends) with the holding member 12 attached to the backlight chassis 4 (fix member 11). Because of this, it is possible to easily change the attachment position of the holding member 12 with respect to the backlight chassis 4 (fix member 11). In other words, it is possible to easily perform the working of narrowing and widening the pitch of the holding members 12.

Besides, in the first embodiment, as described above, the strut member (member for supporting the optical sheet 7) 13 of the lamp holder 6 is separated from the fix member 11 and the holding member 12; the strut member 13 is removably attached to the fix member 11 and the strut member 13 is so structured as to be attachable to an arbitrary position of the fix member 11, it is possible to obtain the above effects even if the lamp holder 6 has the function to support the optical sheet 7.

### Second Embodiment

Next, a structure of a lamp holder of a backlight unit in a second embodiment is described with reference to FIG. 7.

In a lamp holder 16 in the second embodiment, as shown in FIG. 7, a plurality of projections 11c arranged in a predetermined direction (direction in which the guide groove 11b of the fix member 11 extends) are disposed on the guide groove 11b of the fix member 11; and an engagement piece 12c that engages with the projection 11c of the fix member 11 is disposed on the pedestal 12b of the holding member 12. Besides, although not shown, an engagement piece that engages with the projection 11c of the fix member 11 is also disposed on the pedestal of the strut member.

Here, the other structures in the second embodiment are the same as the first embodiment.

In the second embodiment, as described above, the plurality of projections 11c arranged in the predetermined direction (direction in which the guide groove 11b of the fix member 11 extends) are disposed on the guide groove 11b of the fix member 11; and the engagement piece 12c that engages with the projection 11c of the fix member 11 is disposed on the pedestal 12b of the holding member 12; after the holding member 12 is slid in the predetermine direction (direction in which the guide groove 11b of the fix member 11 extends) and moved to a desired position, it is possible to engage the projection 11c of the fix member 11 with the engagement piece 12c of the holding member 12 at the desired position. Accordingly, because the holding member 12 is fixed at the desired position, it is possible to alleviate the holding member 12 deviating from the desired position.

The other effects of the second embodiment are the same as the first embodiment.

### Third Embodiment

Next, a structure of a lamp holder of a backlight unit in a third embodiment is described with reference to FIG. 8.

A lamp holder 26 in the third embodiment, as shown in FIG. 8, besides the fix member 11, the holding member 12 and the strut member 13, further includes a spacer member 14 that is fitted in the guide groove 11b of the fix member 11.

Here, the other structures in the third embodiment are the same as the first embodiment.

In the third embodiment, as described above, in the lamp holder 26 that, besides the fix member 11, the holding member 12 and the strut member 13, further includes a spacer member 14 that is fitted in the guide groove 11b of the fix member 11, if the space member 14 is disposed between holding members 12 adjacent to each other, it is possible to hold the distance between the holding members 12 adjacent to each other. In other words, it is possible to hold the distance between fluorescent lamps (not shown) adjacent to each other.

The other effects of the third embodiment are the same as the first embodiment.

Here, it must be considered that the embodiments disclosed this time are examples in all respects and not limiting. The scope of the present invention is not represented by the description of the above embodiments but represented by the claims and all modifications within the scope of the claims and the meaning equivalent to the claims are included.

For example, in the above embodiments, the examples in which the present invention is applied to the backlight unit disposed in the liquid crystal display device are described. However, the present invention is not limited to these and also applicable to a backlight unit disposed in a display device other than the liquid crystal display device. Further, the present invention is also applicable to an illuminating device other than the backlight unit.

Besides, in the above embodiments, both of the holding member and the strut member are attached to the fix member. However, the present invention is not limited to this and only the holding member may be attached to the fix member without attaching the strut member to the fix member.

1. A lamp holder comprising:
a fix member that is fixed on a chassis; and
a holding member that holds a fluorescent lamp;
wherein the fix member and the holding member are separated from each other; and
the holding member is removably attached to the fix member and the holding member is attachable to an arbitrary position of the fix member.

2. The lamp holder according to claim 1, wherein
the fix member includes a guide groove; and
the holding member includes a pedestal that is fitted in the guide groove of the fix member.

3. The lamp holder according to claim 2, wherein
the guide groove of the fix member is formed into a rail-shape that extends in a predetermined direction.

4. The lamp holder according to claim 3, wherein
a plurality of projections arranged in a predetermined direction are disposed in the guide groove of the fix member; and
an engagement piece that engages with the projection of the fix member is disposed on the pedestal of the holding member.

5. The lamp holder according to claim 1, further comprising a strut member that supports an optical sheet that at least diffuses light from the fluorescent lamp;
wherein the fix member, the holding member and the strut member are separated from each other; and
the strut member is removably attached to the fix member and the strut member is attachable to an arbitrary position of the fix member.

6. The lamp holder according to claim 1, further comprising a spacer member that is disposed between the holding members adjacent to each other.

7. An illuminating device comprising:
the lamp holder described in claim 1; and
a fluorescent lamp that is held by the lamp holder.

8. A display device comprising:
the illuminating device described in claim 7; and
a display panel onto which light emitted from the illuminating device is shined.

9. An illuminating device comprising:
the lamp holder described in claim 2; and
a fluorescent lamp that is held by the lamp holder.

10. An illuminating device comprising:
the lamp holder described in claim 3; and
a fluorescent lamp that is held by the lamp holder.

11. An illuminating device comprising:
the lamp holder described in claim 4; and
a fluorescent lamp that is held by the lamp holder.

12. An illuminating device comprising:
the lamp holder described in claim 5; and
a fluorescent lamp that is held by the lamp holder.

13. An illuminating device comprising:
the lamp holder described in claim 6; and
a fluorescent lamp that is held by the lamp holder.

14. A display device comprising:
the illuminating device described in claim 9; and
a display panel onto which light emitted from the illuminating device is shined.

15. A display device comprising:
the illuminating device described in claim 10; and
a display panel onto which light emitted from the illuminating device is shined.

16. A display device comprising:
the illuminating device described in claim 11; and
a display panel onto which light emitted from the illuminating device is shined.

17. A display device comprising:
the illuminating device described in claim 12; and
a display panel onto which light emitted from the illuminating device is shined.

18. A display device comprising:
the illuminating device described in claim 13; and
a display panel onto which light emitted from the illuminating device is shined.
